(19) United States
(12) Patent Application Publication
(10) Pub. No.: US 2018/0035644 A1
(43) Pub. Date: Feb. 8, 2018

(54) PET TOY

(71) Applicant: Doskocil Manufacturing Company, Inc., Arlington, TX (US)

(72) Inventors: Chris WILSON, Plano, TX (US); Nicholas BAKER, Fort Worth, TX (US); Brittany GREEN, Fort Worth, TX (US); Ryan WILLS, Carrollton, TX (US)

(21) Appl. No.: 15/226,133

(22) Filed: Aug. 2, 2016

(51) Int. Cl. A01K 15/02

(52) U.S. Cl. CPC A01K 15/026

(57) ABSTRACT

A pet toy includes a first member and a second member. The first member is at least partially formed by a plurality of interconnecting elements and defining an interior space. The interior space has a first predetermined shape. The plurality of interconnecting elements form a plurality of openings. The second member has a first part and a second part. The second part has a second predetermined shape. The second predetermined shape has a similar shape to the first predetermined shape. The second part is configured to be disposed within the interior space and the first part is configured to be disposed outside the interior space of the outer covering.

### BACKGROUND

### Object of the Invention

The present invention is directed to a pet toy. In particular, the present invention is directed to a pet toy which is resistant to destruction caused by the chewing action of a pet.

### Description of Related Art

Pet toys, such natural bones and rawhide, have long been given to pets for the purposes of amusement and enjoyment as well as for the exercise and health benefits obtained from vigorous chewing. Although pet toys made from natural materials function adequately, they have been in part replaced by more durable materials such as plastic and rubber.

Conventional pet toys can be made from various materials including thermoplastics such as nylon and urethane, as well as from natural rubber. These toys are designed to be safe for pets and pets generally show a great amount of interest in the toys when first introduced to them.

Some pet toys have openings or areas that enable insertion of treats.

### SUMMARY

A need exists for a pet toy which is durable yet which is relatively soft to bite and chew. Moreover, a need exists for a pet toy that is capable of accepting an animal treat, while at the same time restricting access to the treat. Such restricted access can increase the pet's occupation with the treat. Such a pet toy includes a first member and a second member. The first member is at least partially formed by a plurality of interconnecting elements and defining an interior space. The interior space has a first predetermined shape. The plurality of interconnecting elements form a plurality of openings. The second member has a first part and a second part. The second part has a second predetermined shape. The second predetermined shape has a similar shape to the first predetermined shape. The second part is configured to be disposed within the interior space and the first part is configured to be disposed outside the interior space of the outer covering.

In another embodiment the pet toy includes a first member and a second member. The first is being at least partially formed by a plurality of interconnecting elements and defines an interior space. The interior space has a first predetermined shape. The plurality of interconnecting elements form a plurality of openings. The second member has a second predetermined shape, and is configured to be disposed within the interior space. The second predetermined shape is substantially similar to the first predetermined shape, and at least part of the second member is spaced from the first member when the second member is disposed within the interior space.

### BRIEF DESCRIPTION OF THE DRAWINGS

The invention will be explained in more detail hereinafter with reference to the drawings.

FIG. 1 is a top perspective view of a pet toy according to an embodiment of the present invention;

FIG. 2 is a front elevational view of the pet toy of FIG. 1;

FIG. 3 is a side elevational view of the pet toy of FIG. 1;

FIG. 4 is a bottom plan view of the pet toy of FIG. 1;

FIG. 5 is a cross sectional view taken along lines 5-5 of FIG. 2;

FIG. 6 is a cross section view taken along lines 6-6 of FIG. 3;

FIG. 7 is a front elevational view of the covering portion of the pet toy of FIG. 1 with the bone removed;

FIG. 8 is a bottom plan view of the pet toy of FIG. 7;

FIG. 9 is a top perspective view of the bone of the pet toy of FIG. 1 removed from the covering portion;

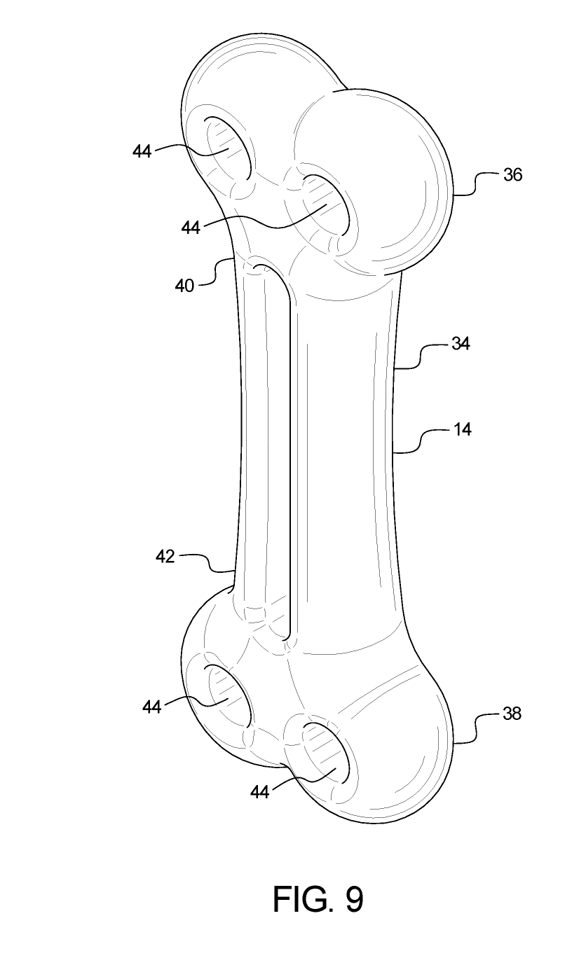

FIG. 10 is a side elevational view of the bone of FIG. 9;

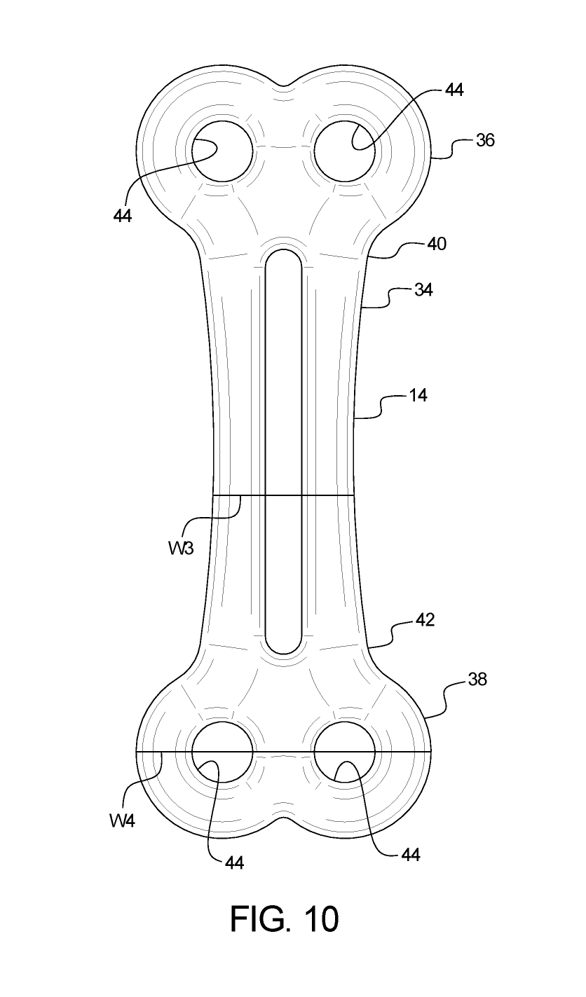

FIG. 11 is a top perspective view of a pet toy according to another embodiment of the present invention;

FIG. 12 is a front elevational view of the pet toy of FIG. 11;

FIG. 13 is a side elevational view of the pet toy of FIG. 11;

FIG. 14 is a cross sectional view taken along lines 14-14 of FIG. 12;

FIG. 15 is a cross sectional view taken along lines 15-15 of FIG. 12;

FIG. 16 is a front elevational view of the covering portion of the pet toy of FIG. 11 with the bone removed;

FIG. 17 is a top perspective view of the bone of the pet toy of FIG. 11 removed from the covering portion;

FIG. 18 is a front elevational view of the bone of FIG. 17;

FIG. 19 is a top perspective view of a pet toy according to another embodiment of the present invention;

FIG. 20 is a side elevational view of the pet toy of FIG. 19;

FIG. 21 is cross sectional view taken along lines 21-21 of FIG. 20;

FIG. 22 is a top perspective view of the covering portion of the pet toy of FIG. 19 with the nut removed;

FIG. 23 is a top perspective view of the nut of FIG. 19 removed from the covering portion;

FIG. 24 is a front elevational view of the nut of FIG. 23; and

FIG. 25 is a side elevational view of the nut of FIG. 23.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

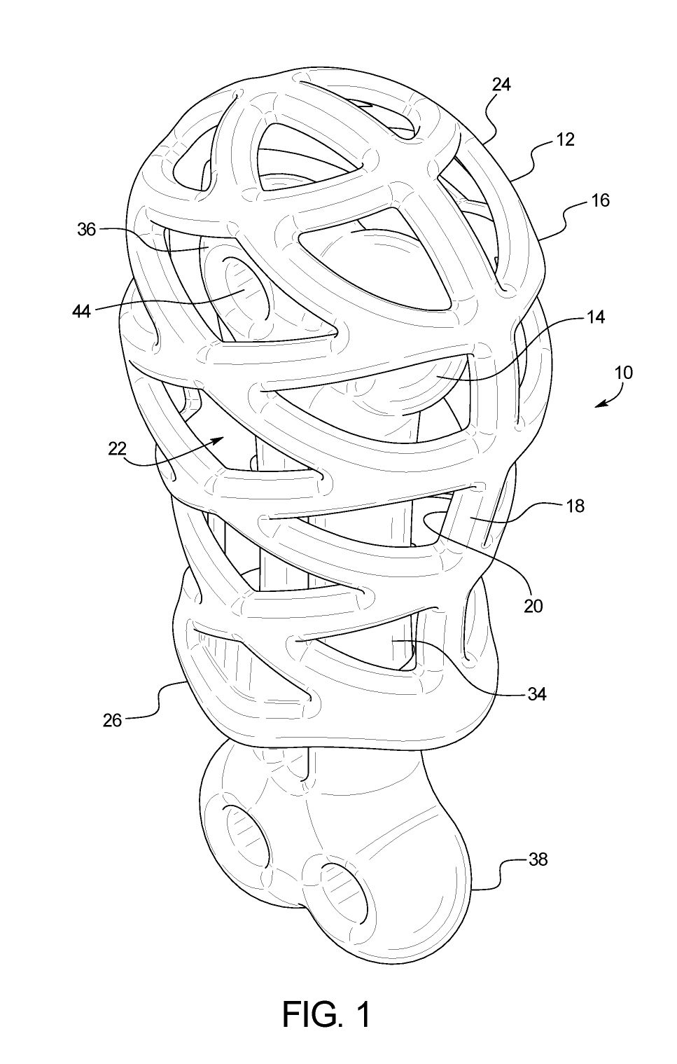

Referring initially to FIG. 1, a pet toy 10 is illustrated in accordance with a first embodiment. In this embodiment, the pet toy includes a first member 12 and a second member 14.

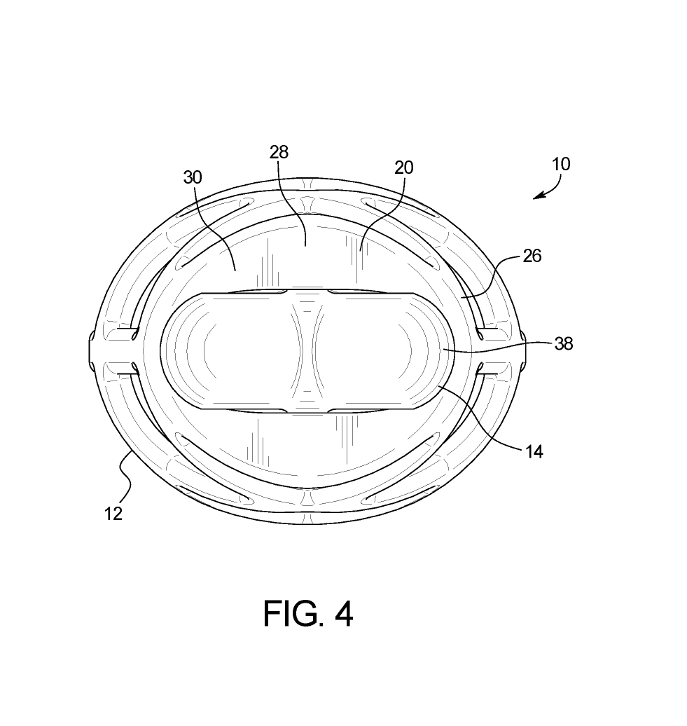

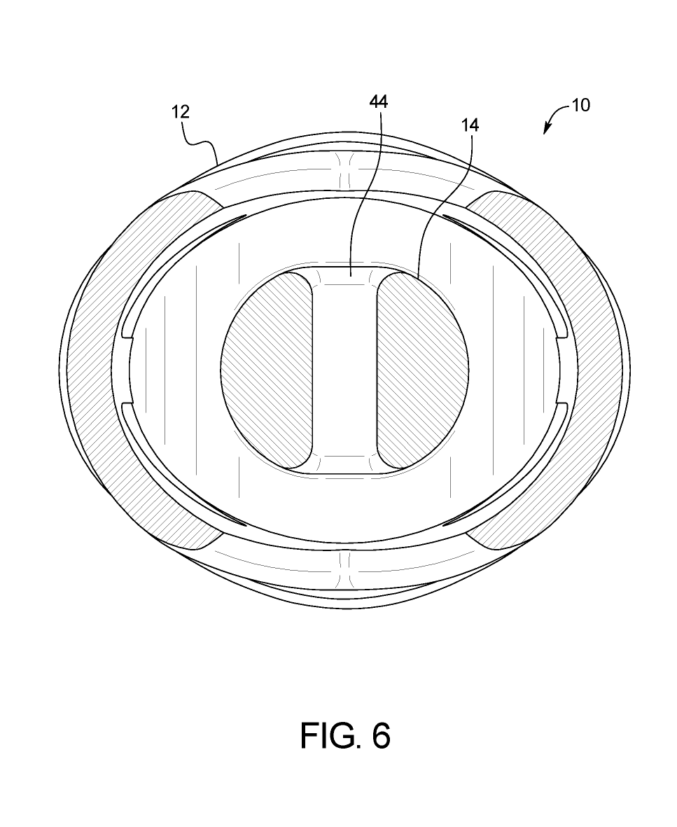

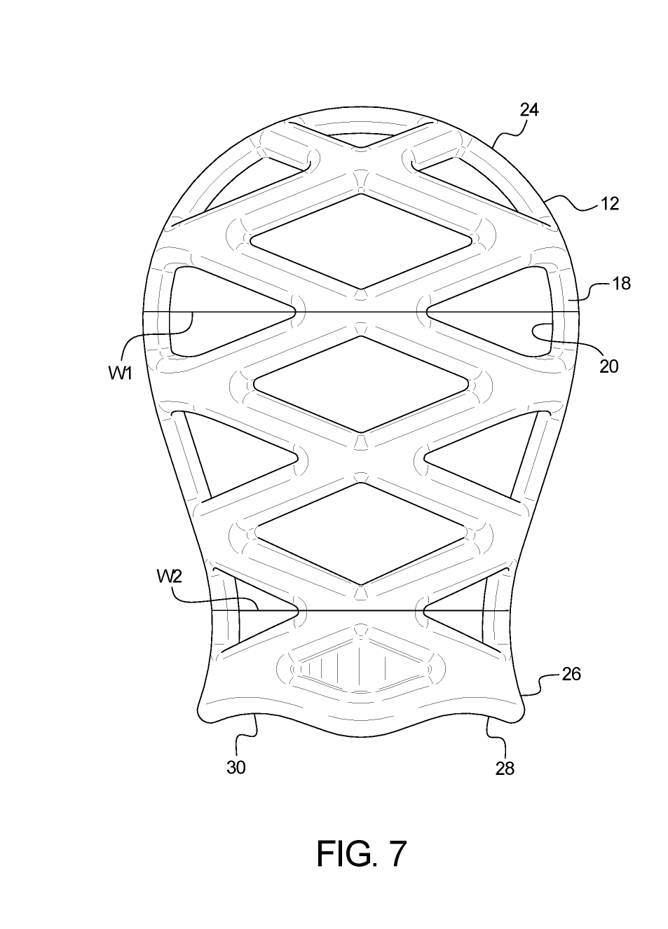

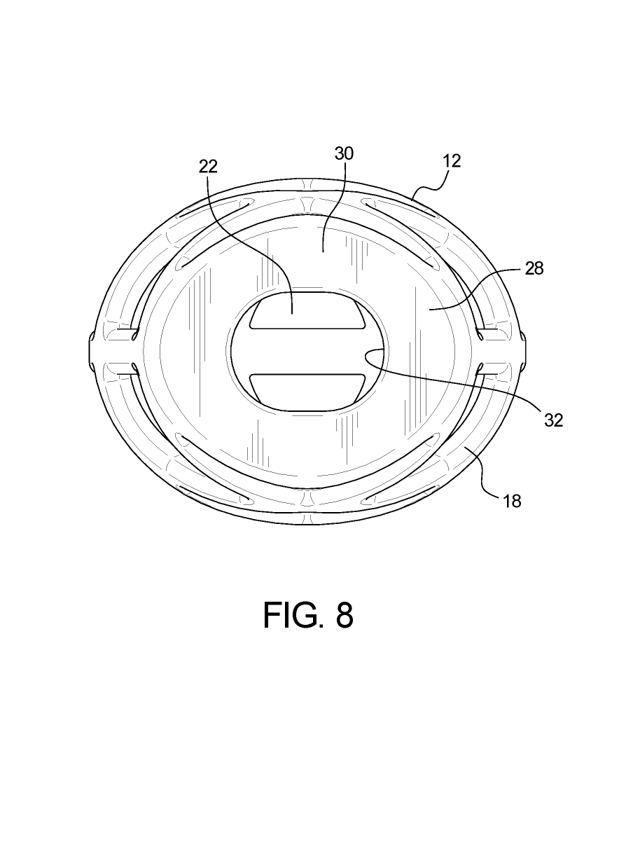

As shown in FIGS. 1-8, the first member 12 is preferably an injection molded rubber or elastic polymeric substance. The first member 12 has a cover portion 16 (outer covering), least partially formed by a plurality of interconnecting elements 18. The interconnecting elements 18 can crisscross or form a grid pattern with a plurality of openings 20, if desired. However, it is noted that the interconnecting elements 18 can form any suitable pattern.

The interconnecting elements 18 form a cavity or interior space 22 having a first predetermined shape that can be viewed through openings 20. As shown in FIGS. 1-5, the openings 20 can have a triangular or diamond shape that enable limited access therethough and into the interior space 22. The openings 20 can be any suitable shape that would enable limited access into the interior space 22.

In one embodiment, the interconnecting elements 18 form an upper or first portion 24 and a lower or second portion 26. In this embodiment, the upper portion 24 has an arcuate or rounded configuration with a width W1. The lower portion 26 has a concave configuration with a width W2. The width W2 of the lower portion 26 is less than the width W1 of the upper portion 24. Accordingly, the interior space 22 of the first member 12 at the upper portion 24 has a diameter that is greater than the diameter of the interior space 22 at the lower portion 26. In one embodiment, the first member 12 has the appearance or shape of a portion of a turkey or chicken leg. Moreover, the interior space 22 has a similar predetermined shape.

The bottom 28 of the lower portion 26 of the first member 12 partially closes access to the interior space 22 with a rubber portion 30. That is, the rubber portion 30 can substantially cover the bottom of the interior space 22, but can have an opening 32 therein that would enable access through the bottom 28 of the first member 12 into the interior space 22.

The second member 14 is preferably a nylon or elastic synthetic polymer. The second member 14 can have a first part 34 and a second part 36. In one embodiment, the first part 34 can have a first predetermined shape and the second part 36 can have a second predetermined shape. In this embodiment, the first part 34 has an arcuate or rounded configuration with a width W3. The second part 36 has a generally cyidrical configuration with a width W4. The width W4 of the second part 36 is less than the width W3 of the first part 34. Accordingly, the first part 34 has a diameter that is greater than the diameter of the second part 36. In one embodiment, the first member 12 has the appearance or shape of a bone of a turkey or chicken leg.

As shown in 1-6, 9 and 10, the second member 14 includes a third part 38, the third part 38 is generally identical or substantially similar to the second part 36; however, the third part 36 can be any suitable configuration. In one embodiment, the first part 34 has a first end 40 and a second end 42, and the second part 36 is disposed on the first end 40 and the third part 38 is disposed on the second end 42.

The second member 14 can have openings 44 in any portion thereof for the insertion of edible (or any other type of) pet treats. In one embodiment, the openings 44 can be can be disposed on the second 36 or third part 38. The openings 44 can be generally circular or have any suitable configuration.

As shown in FIGS. 1-6, the second member 14 can be inserted or disposed in the first member 12. In one embodiment, the second part 36 of the second member 14 is disposed outside of the interior space 22 and extends partially through the opening 32 in the bottom 28 of the first member 12, with the first part 34 of the second member 14 being disposed within the interior space 22 of the first member 12.

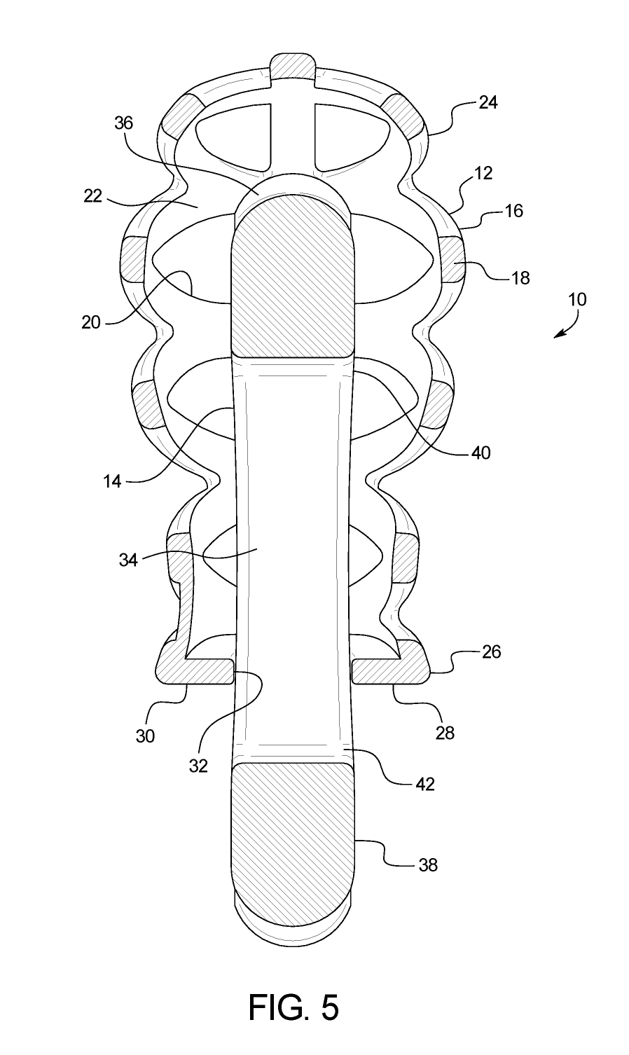

As can be seen in FIGS. 1 and 5, the portion of the second member 14 is disposed within the interior space 22 has a shape that is generally similar to the interior space 22 of the first member 12. That is, the second part 36 of the second member 14 has a diameter that is less than the first part 34 of the second member 14. While the diameter of the second portion 26 of the interior space 22 has a diameter that is less than the first portion 24 of the interior space 22.

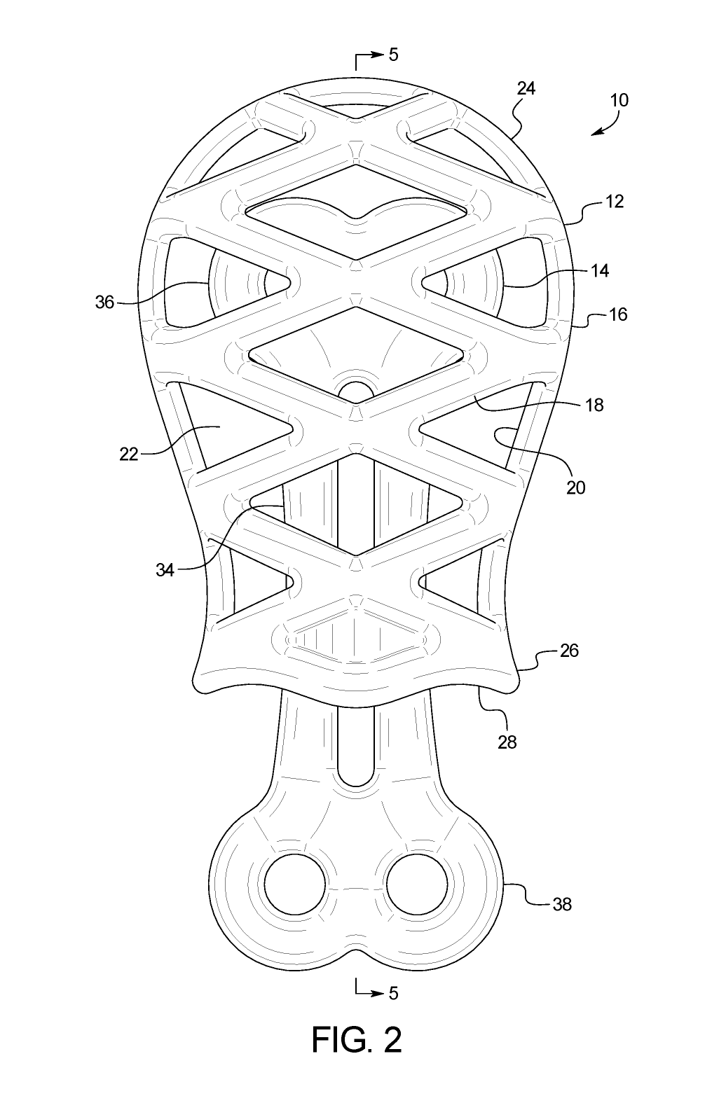

Moreover, a portion of the second member 14 is disposed outside of the interior space 22. As illustrated in FIGS. 2, 3 and 5, the second part 36 of the second member 14 and at least a portion of the first part 34 are disposed in the interior space 22 of the first member 12 and the third member 38 and at least a portion of the first part 34 are disposed outside of the interior space 22.

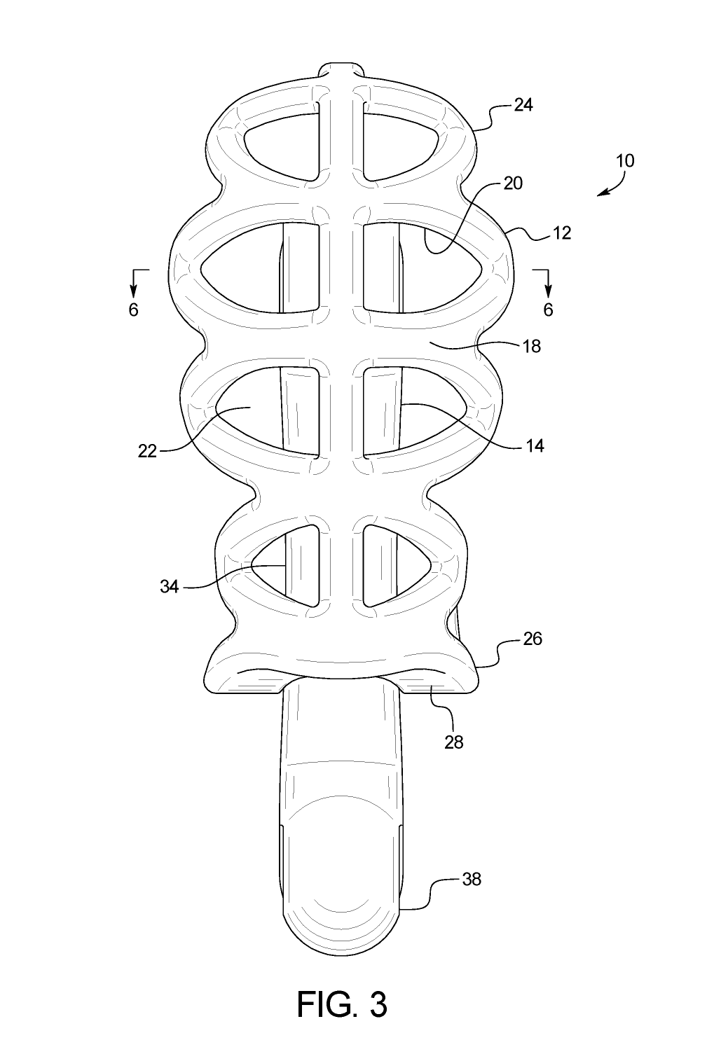

As shown in FIGS. 3-5 and 8, the opening 32 in the bottom 28 of the first member 12 has a similar shape as the first part 34 of the second member 14. Further, the opening 32 is generally smaller than the overall structure of the second and third parts 36, 38 of the second member 14. Accordingly, the second member 14 can slide within the opening 32 but is restricted or prevented from being withdrawn or fully inserted into the interior space 22 due to the structure and size of the second and third parts 36, 38.

The interconnecting elements 18 form a web or grid configuration in which the openings 20 encompass a larger area than the interconnecting elements 18. Accordingly, the interior space 22 within the first member 12 is generally visible through the openings 20. Such a configuration enables a pet limited access to the second member 14 disposed within the interior space 22. However, due to the overall structure and material of the first member 12, the pet would have difficulty removing the second member 14 from the interior space 22.

In operation, a pet owner or user can remove the second member 14 from the interior space 22 and add edible treats or other edible foodstuff to the openings 44 in the second member 14. The second member 14 can then be inserted back through the openings 20 in the first member 12 such that at least the second part 36 of the second member 14 is disposed within the interior space 22. Alternatively, the pet owner or user may access the second member 14 through the openings 20 in the first member 12 to add edible treats or other edible foodstuff to the openings 44 in the second member 14.

The treat can then be provided to the pet or animal, and the animal can enjoy the pet toy 10. The animal will attempt to ingest the edible treats or other edible foodstuff, but only has limited access through the openings 20 in the first member 12. Such a structure will increase the time and enjoyment of the pet or animal.

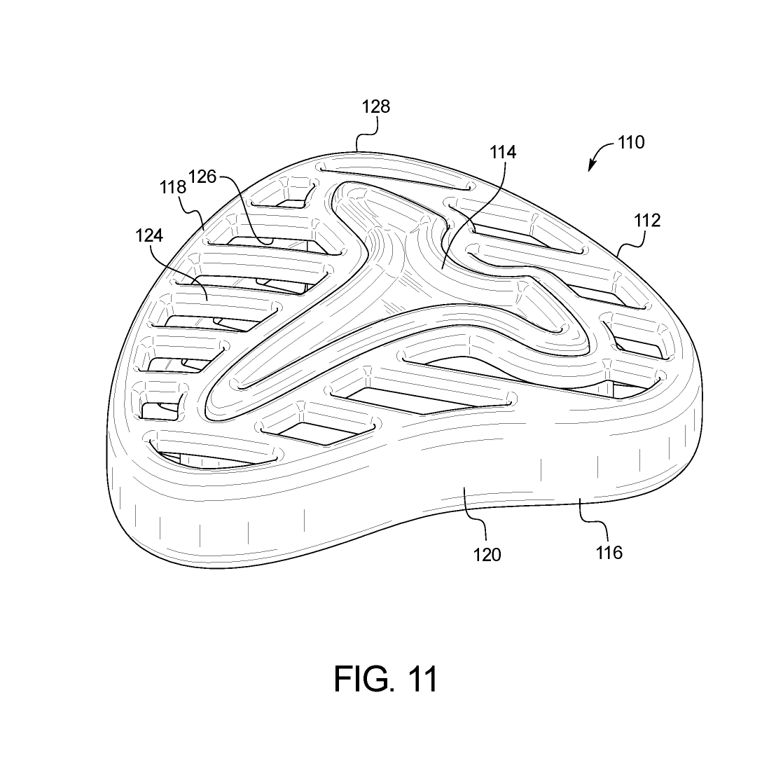

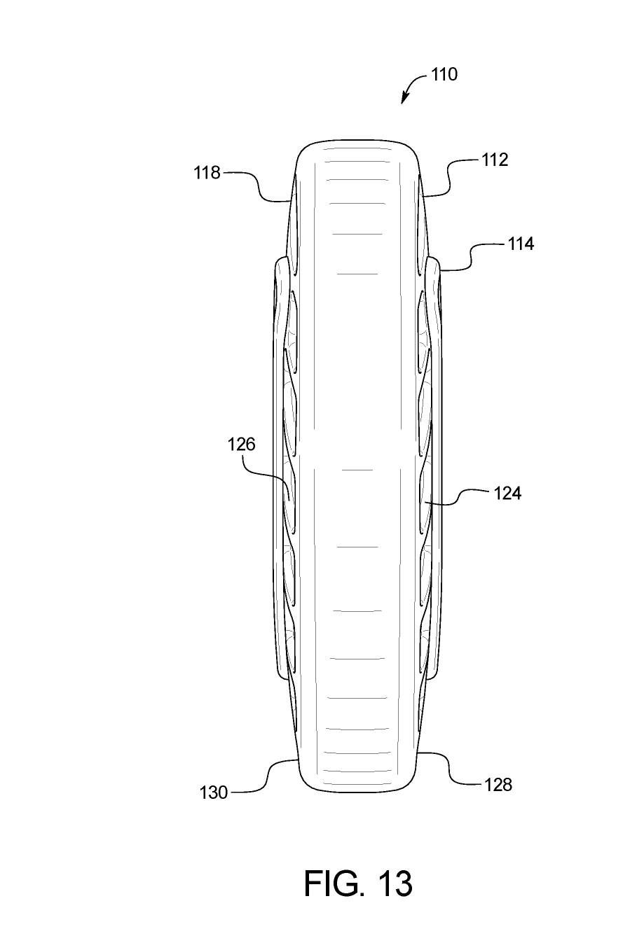

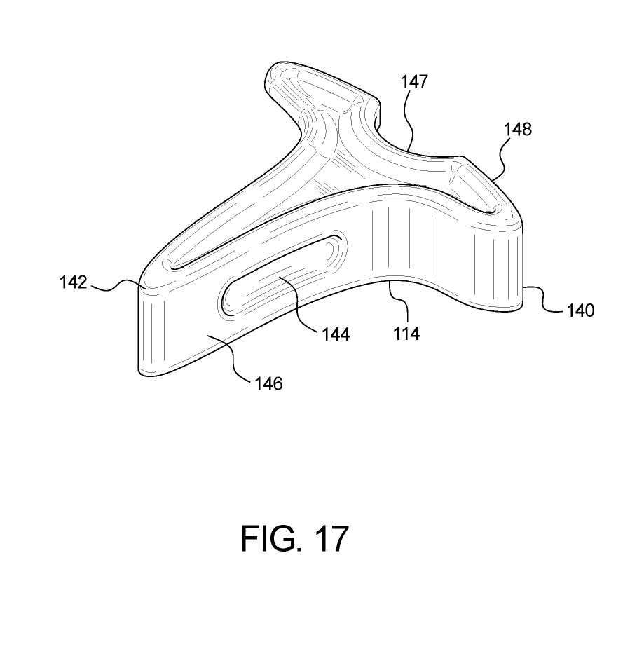

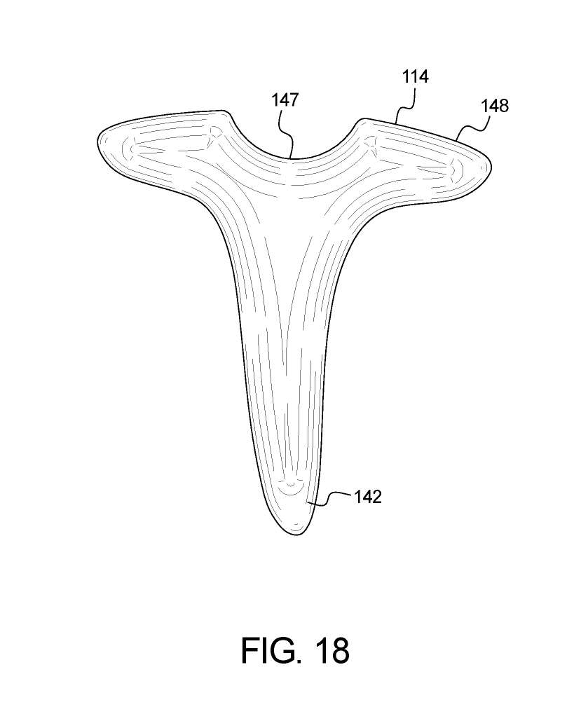

A second embodiment of the present invention is shown in FIGS. 11-18. In this embodiment, a pet toy 110 is illustrated that includes a first member 112 and a second member 114.

The first member 112 is preferably an injection molded rubber or elastic polymeric substance. The first member 112 has a cover portion 116, least partially formed by a plurality of interconnecting elements 118. The interconnecting elements 118 include an outer interconnecting member or wall 120, an inner interconnecting member or wall 122 and a plurality of cross interconnecting members 124. The plurality of cross interconnecting members 124 generally extend between the outer interconnecting member 120 and the inner interconnecting member 122 and form a grid pattern with a plurality of openings 126, if desired. However, it is noted that the interconnecting elements 118 can form any suitable pattern. In this embodiment, the first member 112 has a “steak” shape.

The inner and outer interconnecting members 120, 122 extend the width of the first member 112, while the plurality of cross interconnecting members 124 are disposed on the top 128 and bottom 130 of the first member 112 and only extend partially along the inner and outer interconnecting members 120, 122.

The interconnecting elements 118 (e.g., the inner interconnecting member 120) form a first cavity or interior space 132 having a first predetermined shape and interconnecting elements 118 (e.g., the outer interconnecting member 120, the inner interconnecting member 122, and the plurality of cross interconnecting members 124) form a second cavity or interior space 134 having a predetermined shape. In this embodiment, the first interior space 132 has a generally t-shape and is formed by an interconnecting member (e.g., the inner interconnecting member 120).

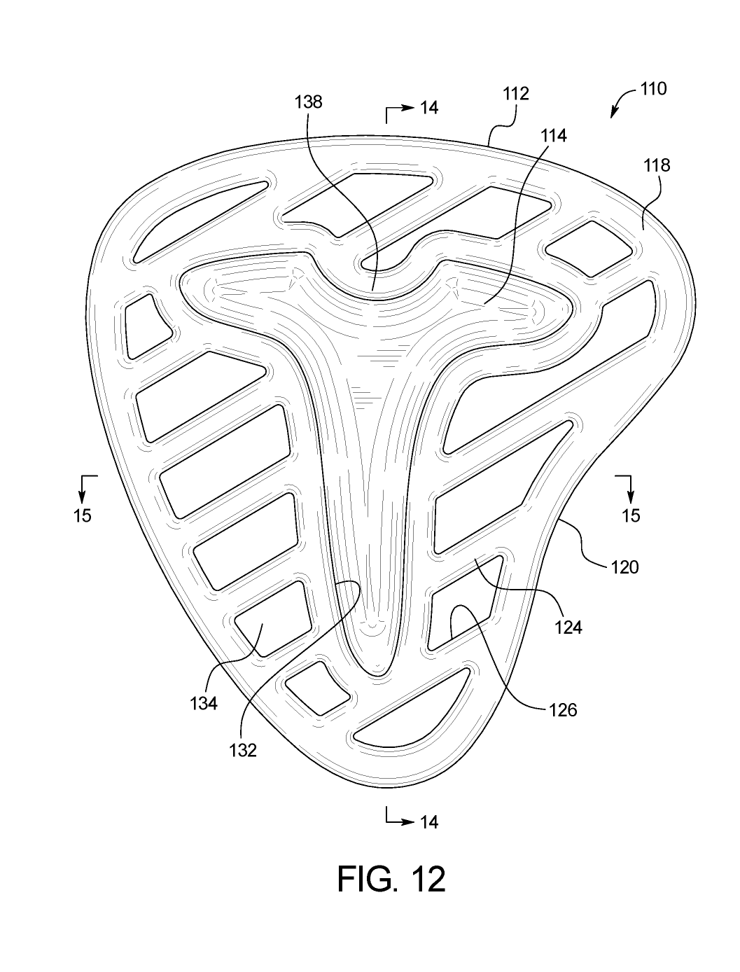

Since the plurality of cross interconnecting members 124 are disposed on the top 128 and bottom 130 of the first member 112 and only extend partially along the inner and outer interconnecting members 120, 122, this structure forms the second interior space 134. The outer interconnecting member 122 has a generally triangular (steak) shape, forming a predetermined shape for the second interior space 134. As shown in FIGS. 11 and 12, the openings 126 can have a rectangular shape that enable limited access therethough and into the second interior space 134. The openings 126 can be any suitable shape that would enable limited access into the interior space 134.

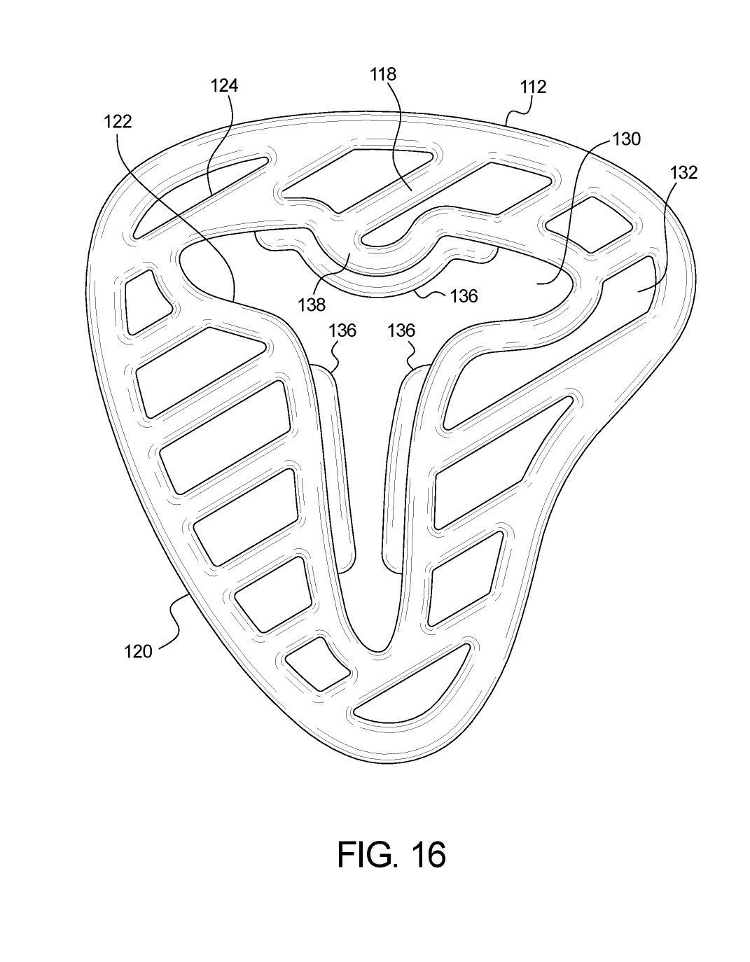

As shown in FIG. 16, the first interior space 132 has a plurality of protrusions 136 configured to engage the second member 114. Each of the protrusions 136 preferably extends transversely form the inner interconnecting member 120, and into the first inner space 132. In one embodiment, three protrusions 136 extend from the inner interconnecting member 120. The protrusions each extend in a longitudinal direction so as to be longer than the distance from which they extend from the inner interconnecting member 120.

Moreover, the inner interconnecting member 120 includes an arcuate protrusion 138 at the top portion of the T-shape. The arcuate protrusion extends inwardly from the inner interconnecting member 120.

The second member 114 is preferably a nylon or elastic synthetic polymer. The second member 114 can have a first part 140 and a second part 142. In one embodiment, the first part 140 can have a first predetermined shape and the second part 142 can have a second predetermined shape. In this embodiment, the first part 140 is generally T-shaped. The second part 142 also is generally T-shaped. In this embodiment, the first part 140 and the second part 142 have the same general shape and can appears as a one-piece member. In one embodiment, the second member 114 has the appearance or shape of a T-bone of a steak.

The second member 114 can have grooves 144 in an outer wall 146 thereof. In one embodiment, the second member 114 has three grooves 144 disposed so as to correspond to the protrusions 136 of the first member 112. Each of the grooves 144 has a predetermined length that is preferably longer than the depth of the groove 144. Moreover, the cross-sectional configuration and the length of the grooves 144 corresponds to the cross sectional configuration and length of the corresponding protrusions 136.

The second member 114 has an arcuate groove 147 extending transversely to the longitudinal direction of the groove 144 on a top 148 portion thereof. Arcuate groove 147 is sized and configured to match the inner interconnecting member 120 includes an at the top portion of the T-shape

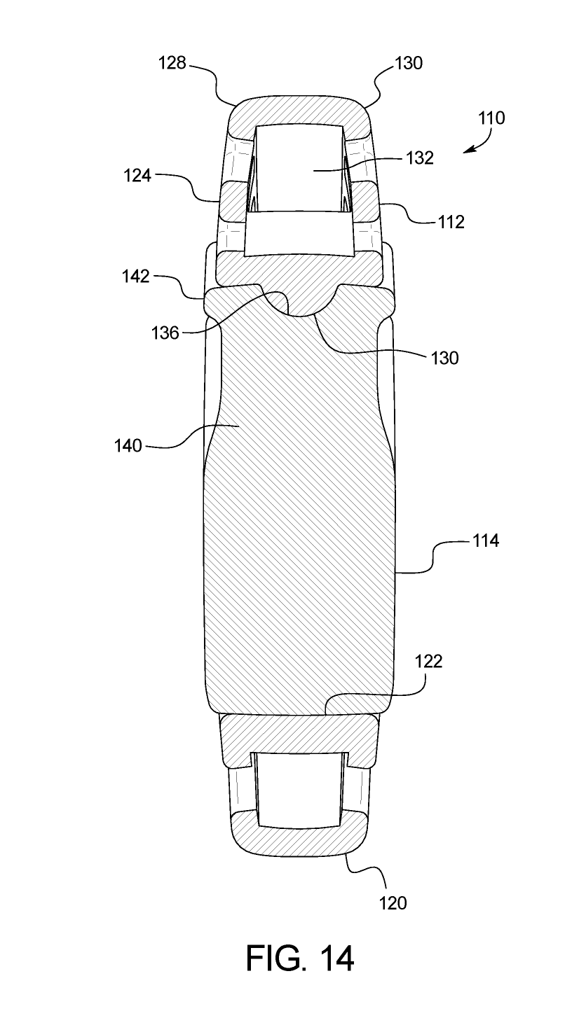

As shown in FIGS. 14, 15, 17 and 18, the second member 114 can be inserted or disposed in the first member 112. In one embodiment, the second part 142 of the second member 114 is disposed outside of the interior space and extends partially, with the first part 140 of the second member 114 being disposed within the interior space of the first member 112.

As can be seen in FIG. 2, the portion of the second member 114 is disposed within the interior space has a shape that is generally similar to the interior space of the first member 112. That is, the second part 142 of the second member 114 has a generally T-shaped configuration as does the interior space.

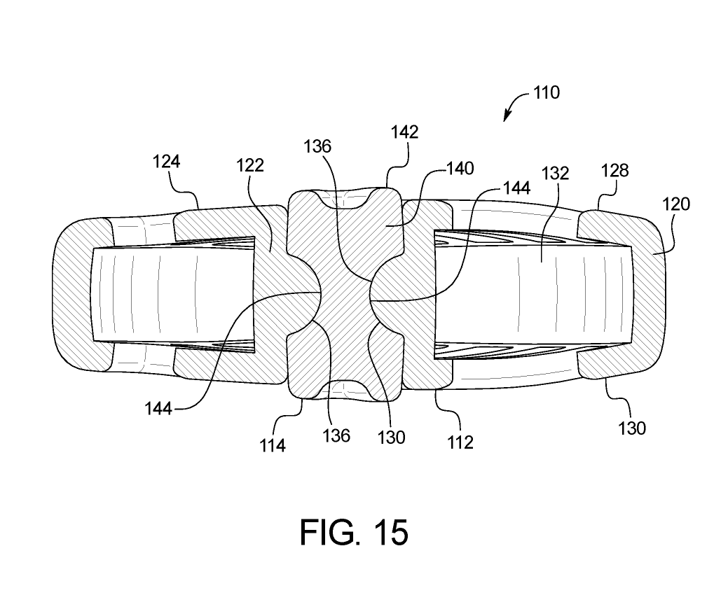

Moreover, a portion of the second member 114 is disposed outside of the first interior space 132. As illustrated in FIGS. 14 and 15, the second part 142 of the second member 112 and at least a portion of the first part 140 are disposed in the interior space first interior space 132 of the first member 112. When the second member 114 is disposed in the first interior space 132, the protrusions 136 engage the grooves 144. Accordingly, along with a friction fit between the second member 114 and the inner interconnecting wall 120, the protrusions 136 engaging the grooves 144 can make the second member 114 difficult to remove from the first member 112 by a pet or animal.

The cross interconnecting members 124 form a web or grid configuration in which the openings 126 encompass a larger area than the cross interconnecting members 124. Accordingly, the second interior space 134 within the first member 112 is generally visible through the openings. Such a configuration enables a pet limited access to the second interior space 134.

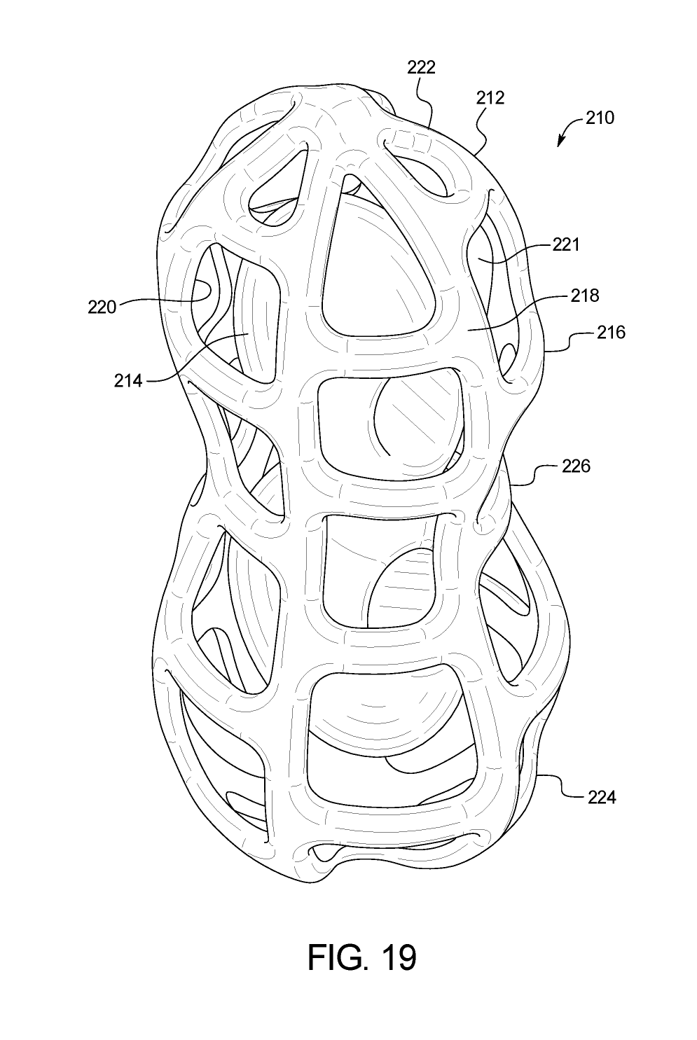

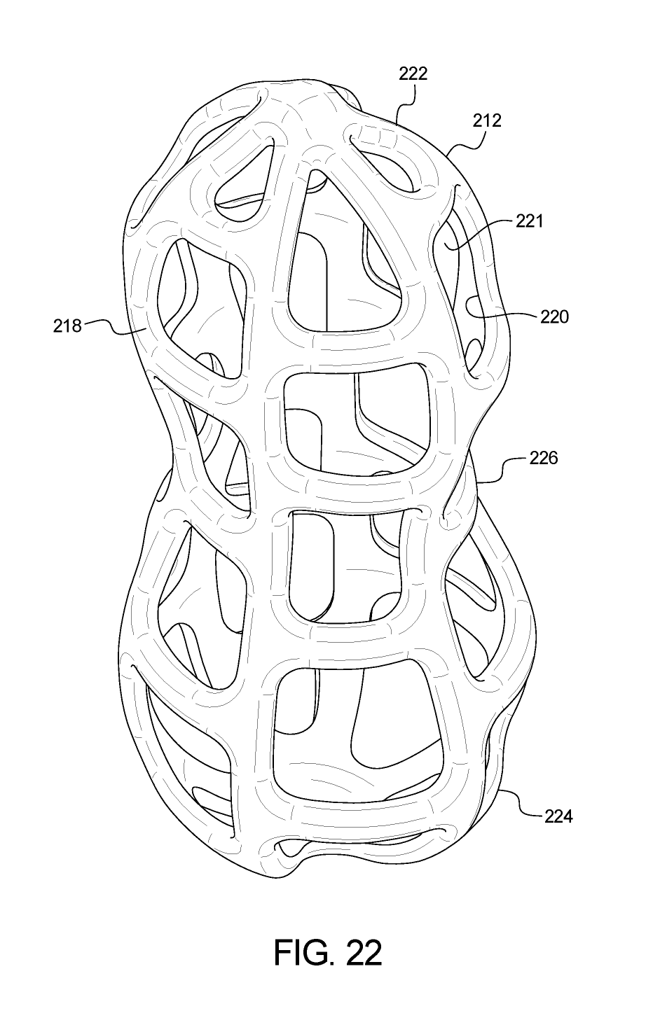

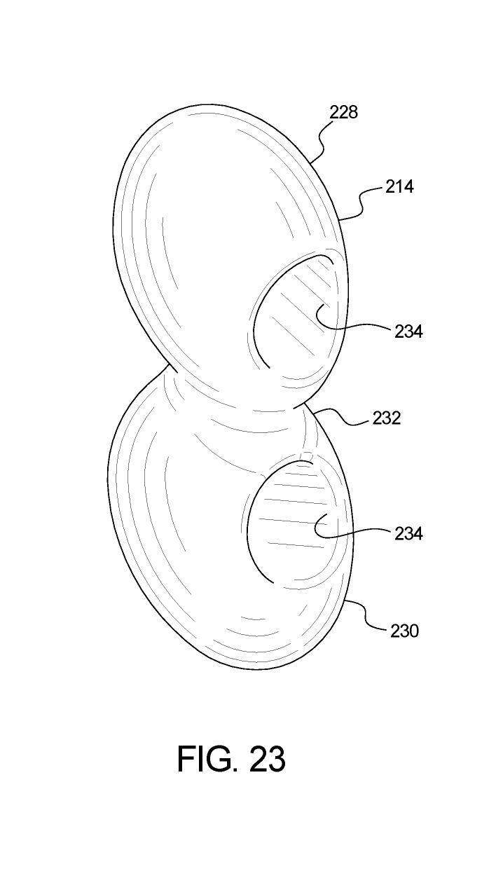

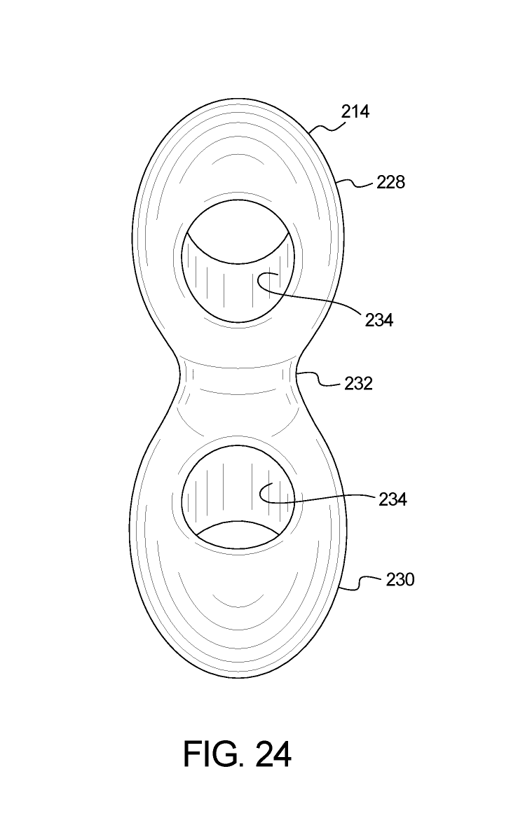

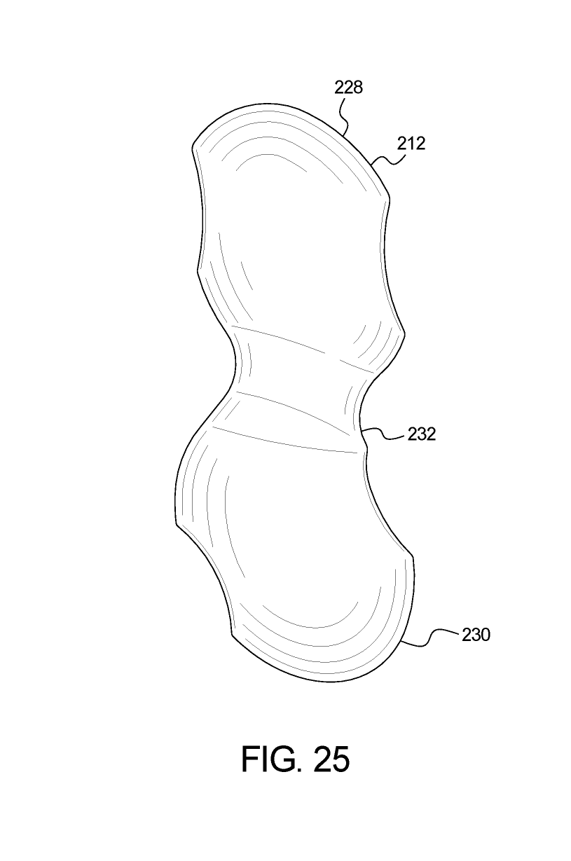

FIGS. 19-25 illustrate a third embodiment of the present invention. In this embodiment, the pet toy 210 includes a first member 212 and a second member 214.

The first member 212 is preferably an injection molded rubber or elastic polymeric substance. The first member 212 has a cover portion 216, least partially formed by a plurality of interconnecting elements 218. The interconnecting elements 218 can crisscross or form a grid pattern with a plurality of openings 220, if desired. However, it is noted that the interconnecting elements 218 can form any suitable pattern.

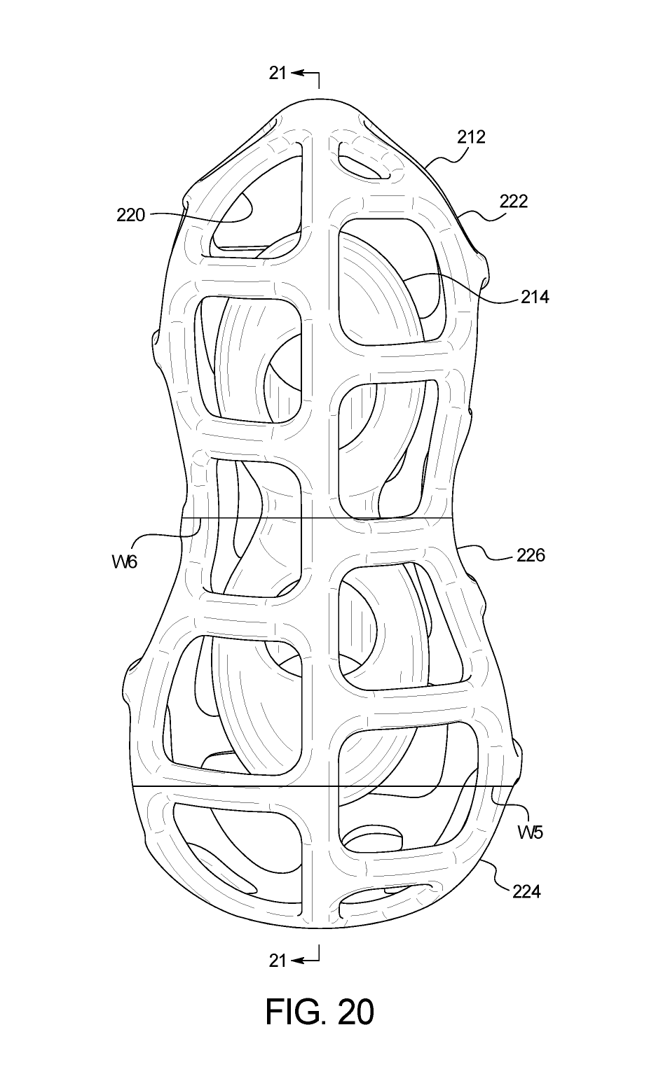

The interconnecting elements 218 form a cavity or interior space 221 having a first predetermined shape that can be viewed through openings 220. As shown in FIGS. 19 and 20, the openings 220 can have a triangular or diamond shape that enable limited access therethough and into the interior space. The openings 220 can be any suitable shape that would enable limited access into the interior space.

In this embodiment, the interconnecting elements 218 form an upper or first portion 222, a lower or second portion 224, and a middle or third portion 226. In this embodiment, the upper and lower portion 222, 224 have an arcuate or rounded configuration with a generally the same width W5 or diameter. The middle portion 226 has a concave configuration with a width W6. The width W6 of the middle portion 226 is less than the width W5 of the upper portion 222 and the lower portion 224. Accordingly, the interior space 221 of the first member 212 at the upper portion 222 and the lower portion 224 has a diameter that is greater than the diameter of the interior space 221 at the middle portion 226. In one embodiment, the first member 212 has the appearance or shape of a peanut shell. Moreover, the interior space 221 has a similar predetermined shape.

The second member 214 is preferably a nylon or elastic synthetic polymer. The second member 214 can have a predetermined shape that is defined by a first part 228, a second part 230, and a third part 232. In one embodiment, the first part 228 and second part 230 have an arcuate or rounded configuration with a width W7. The third part 232 has a generally cylindrical or concave configuration with a width W8. The width W8 of the third part 232 is less than the width W7 of the first part 228 and second part 230. Accordingly, the first part 228 and the second part 230 have a diameter that is greater than the diameter of the third part 232. In one embodiment, the second member 214 has the appearance or shape of a peanut.

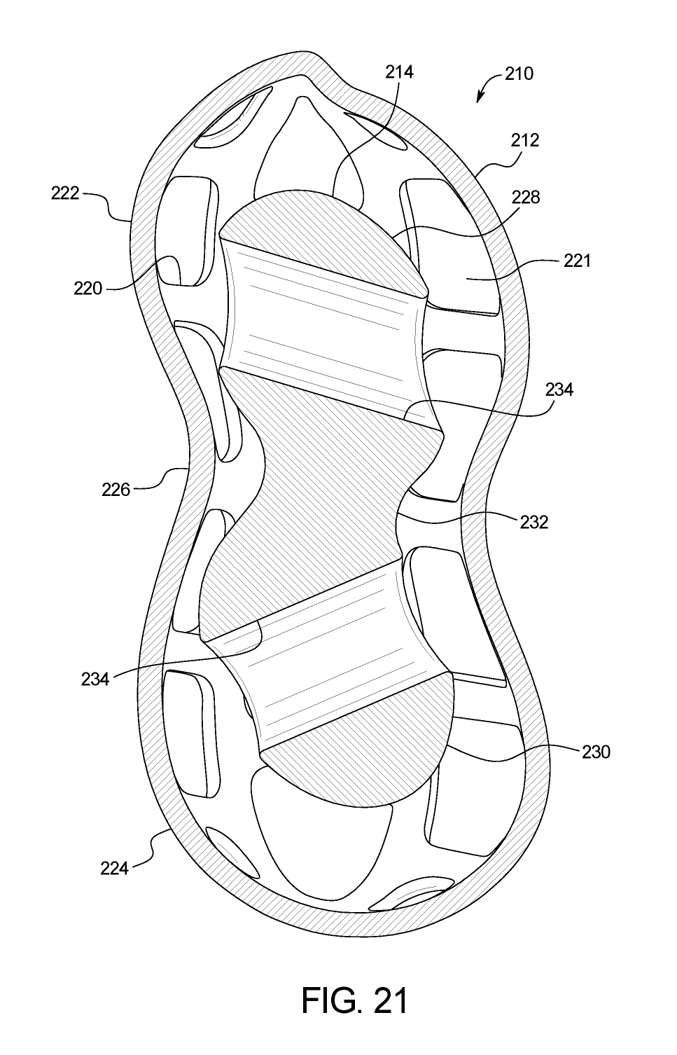

The second member 214 can have openings 234 in any portion thereof for the insertion of edible (or any other type of) pet treats. In one embodiment, the openings 234 can be can be disposed on the first and/or second part 228, 230. The openings 234 can be generally circular, cylindrical or have any suitable configuration. As shown in FIG. 21, the openings 234 can pass completely through the first and second parts 228, 230.

As shown in FIG. 19-21, the second member 214 can be inserted or disposed in the first member 212. The second member 214 vernally has a shape that is similar to the interior space 221 of the first member 212. That is, the first and second parts 228, 230 of the second member 214 have a diameter that is greater than the third part 232 of the second member 214. While the diameter of the middle portion 226 of the interior space 221 has a diameter that is less than the first and second portions 22, 224 of the interior space 221. When disposed with the interior space 221, at least part of the second member 214 is spaced from the first member 212 when the second member 214 is disposed within the interior space 221.

The interconnecting elements 218 form a web or grid configuration in which the openings 220 encompass a larger area than the interconnecting elements 218. Accordingly, the interior space 221 within the first member 212 is generally visible through the openings 220. Such a configuration enables a pet limited access to the second member 214 disposed within the interior space 221. However, due to the overall structure and material of the first member 212, the pet would have difficulty removing the second member 214 from the interior space 221.

In operation, a pet owner or user can remove the second member 214 from the interior space 221 and add edible treats or other edible foodstuff to the openings 234 in the second member 214. The second member 214 can then be inserted back through one of the plurality of openings 220 in the first member 212 such that at least the second part 230 of the second member 214 is disposed within the interior space 221. Alternatively, the pet owner or user may access the second member 214 through the openings 220 in the first member 212 to add edible treats or other edible foodstuff to the openings 234 in the second member 214.

The pet toy 210 can then be provided to the pet or animal, and the animal can enjoy the pet toy 210. The animal will attempt to ingest the edible treats or other edible foodstuff, but only has limited access through the openings 220 in the first member 212. Such a structure will increase the time and enjoyment of the pet or animal.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “portion,” or “member” when used in the singular can have the dual meaning of a single part or a plurality of parts. Accordingly, these terms, as utilized to describe the present invention should be interpreted relative to a Pet Toy.

The terms of degree such as “substantially”, as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A pet toy, comprising:
a first member being at least partially formed by a plurality of interconnecting elements and defining an interior space, the interior space having a first predetermined shape, and the plurality of interconnecting elements forming a plurality of openings; and
a second member having a first part and a second part, the second part having a second predetermined shape, the second predetermined shape having a similar shape to the first predetermined shape, the second part configured to be disposed within the interior space and the first part configured to be disposed outside the interior space of the outer covering.

2. The pet toy according to claim 1, wherein
the first member is formed from rubber and the second member is formed from nylon.

3. The pet toy according to claim 1, wherein
the second part is visible through the openings when the second part is disposed within the interior space.

4. The pet toy according to claim 1, wherein
the interior space is defined by an inner surface, and the inner surface has a protrusion, and
the second part has a groove configured to engage the protrusion.

5. The pet toy according to claim 1, wherein
the second member is frictionally held with the interior space.

6. The pet toy according to claim 1, wherein
the second part includes an opening sized and configured to hold a pet treat.

7. The pet toy according to claim 1, wherein
the first part includes an opening sized and configured to hold a pet treat.

8. The pet toy according to claim 1, wherein
the interior space is sized and configured to hold a pet treat.

9. The pet toy according to claim 1, wherein
the interconnecting elements define the interior space.

10. A pet toy, comprising:
a first member being at least partially formed by a plurality of interconnecting elements and defining an interior space, the interior space having a first predetermined shape, and the plurality of interconnecting elements forming a plurality of openings; and
a second member having a second predetermined shape, and configured to be disposed within the interior space, the second predetermined shape being substantially similar to the first predetermined shape, and at least part of the second member being spaced from the first member when the second member is disposed within the interior space.

11. The pet toy according to claim 10, wherein
the first member is formed from rubber and the second member is formed from nylon.

12. The pet toy according to claim 10, wherein
the second member is visible through the openings when the second member is disposed within the interior space.

13. The pet toy according to claim 10, wherein
the second member includes an opening sized and configured to hold a pet treat.

14. The pet toy according to claim 10, wherein
the interior space is sized and configured to hold a pet treat.

15. The pet toy according to claim 10, wherein
the interconnecting elements define the interior space.

16. The pet toy according to claim 10, wherein
the second member is frictionally held with the interior space.

17. The pet toy according to claim 10, wherein
the second member is sized and configured to pass through at least one opening of the plurality of openings.
